(19) United States
(12) Patent Application Publication
(10) Pub. No.: US 2013/0159138 A1
(43) Pub. Date: Jun. 20, 2013

(54) FRAUDULENT-PURCHASE ALARM SYSTEM, FRAUDULENT-PURCHASE ALARM METHOD, AND RECORDING MEDIUM

(71) Applicant: NEC BIGLOBE, LTD., Tokyo (JP)

(72) Inventor: Shigeru NAGASAKA, Tokyo (JP)

(73) Assignee: NEC BIGLOBE, LTD., Tokyo (JP)

(21) Appl. No.: 13/720,887

(22) Filed: Dec. 19, 2012

(30) Foreign Application Priority Data
Dec. 20, 2011 (JP) 2011-278480

(51) Int. Cl. G06Q 30/06

(52) U.S. Cl. CPC G06Q 30/0609
USPC 705/26.35

(57) ABSTRACT

A fraudulent-purchase alarm system for issuing an alarm about a fraudulent purchase of an article for sale includes: a first storage that stores a price of the article for sale; a second storage that stores purchase amounts of articles for sale purchased by a user of the fraudulent-purchase alarm system; a third storage that stores an upper limit of a total purchase amount of the user; and a controller that, upon receiving a purchase request to purchase the article for sale and identification information about the user, refers to the first to third storages to issue an alarm about a fraudulent purchase if a sum of the purchase amounts of articles already purchased by the user identified by the identification information and the price of the article for sale indicated in the purchase request exceeds the upper limit, wherein the controller lowers the upper limit if a predetermined condition for preventing a fraudulent purchase is met.

This application is based upon and claims the benefit of priority from Japanese patent application No. 2011-278480, filed on Dec. 20, 2011, the disclosure of which is incorporated herein in its entirety by reference.

### BACKGROUND OF THE INVENTION

1. Field of the Invention

The present invention relates to a fraudulent-purchase alarming system, a fraudulent-purchase alarm method, and a recording medium.

2. Description of the Related Art

It has become common to purchase articles for sale, such as commodities, content, and services, via a communication line such as the Internet.

JP10-304332A describes a technique that enables preventing purchase excess PPV (Pay Per View) programs which are examples of articles for sale.

According to the technique described in JP10-304332A, a user specifies the upper limit of the total purchase amount within a period of one cycle (for example, one month) in advance. If the user's further purchase of a PPV program will cause the total purchase amount within the period of one cycle to exceed the upper limit, an alarm is issued to the user.

When a user purchases an article for sale via a communication line such as the Internet, the user purchases the article using identification information (ID) about the user. The user identified by the identification information is charged for the article.

As such, if a third party fraudulently obtains and uses identification information about a user to fraudulently purchase an article for sale, the user identified by the identification information used at the time of purchase is charged for the article fraudulently purchased by the third party.

According to the technique described in JP10-304332A, an alarm is issued to a user if the total purchase amount exceeds a predetermined upper limit. Unfortunately, with this technique, a user identified by identification information is not aware of his/her loss until the total purchase amount of articles for sale fraudulently purchased by a third party exceeds the predetermined upper limit, which is a fixed value.

Thus, there is a need for a technique that enables earlier detection of a fraudulent purchase made by a third party who has fraudulently obtained identification information about a user.

### SUMMARY OF THE INVENTION

An object of the present invention is to provide a fraudulent-purchase alarm system, a fraudulent-purchase alarm method, and a recording medium that are capable of solving the above-described problem.

A fraudulent-purchase alarm system for issuing an alarm about a fraudulent purchase of an article for sale, according to an exemplary aspect of the invention, includes:
a first storage that stores a price of the article for sale;
a second storage that stores purchase amounts of articles for sale purchased by a user of the fraudulent-purchase alarm system;
a third storage that stores an upper limit of a total purchase amount of the user; and
a controller that, upon receiving both a purchase request to purchase the article for sale and identification information about the user, refers to the first to third storages to issue an alarm about a fraudulent purchase if a sum of the purchase amounts of articles already purchased by the user identified by the identification information and the price of the article for sale indicated in the purchase request exceed the upper limit,
wherein the controller lowers the upper limit if a predetermined condition for preventing a fraudulent purchase is met.

A fraudulent-purchase alarm method in a fraudulent-purchase alarming system for issuing an alarm about a fraudulent purchase of an article for sale, according to an exemplary aspect of the invention, includes:
storing a price of the article for sale in a first storage;
storing purchase amounts of articles for sale purchased by a user of the fraudulent-purchase alarm system in a second storage;
storing an upper limit of a total purchase amount of the user in a third storage;
upon receiving a purchase request to purchase the article for sale and identification information about the user, referring to the first to third storages to issue an alarm about a fraudulent purchase if a sum of the purchase amounts of articles already purchased by the user identified by the identification information and the price of the article for sale indicated in the purchase request exceed the upper limit; and
lowering the upper limit if a predetermined condition for preventing a fraudulent purchase is met.

A computer-readable recording medium, according to an exemplary aspect of the invention, which records a program for causing a computer to perform includes:
a first storage process of storing a price of an article for sale in a first storage;
a second storage process of storing, in a second storage, purchase amounts of articles for sale purchased by a user of a fraudulent-purchase alarm system for issuing an alarm about a fraudulent purchase of an article for sale;
a third storage process of storing an upper limit of a total purchase amount of the user in a third storage;
a control process of, upon receiving a purchase request to purchase the article for sale and identification information about the user, referring to the first to third storages to issue an alarm about a fraudulent purchase if a sum of the purchase amounts of articles already purchased by the user identified by the identification information and the price of the article for sale indicated in the purchase request exceed the upper limit; and
an upper limit changing process of lowering the upper limit if a predetermined condition for preventing a fraudulent purchase is met.

The above and other objects, features, and advantages of the present invention will become apparent from the following description with reference to the accompanying drawings which illustrate an example of the present invention.

### BRIEF DESCRIPTION OF THE DRAWINGS

FIG. 1 is a block diagram showing a fraudulent-purchase alarm system in a first exemplary embodiment;

FIG. 2 is a diagram showing an example of customer information 101b including items of user information 101a;

FIG. 3 is a diagram showing an example of upper limit information 103a indicating the upper limit for each user;

FIG. 4 is a diagram showing an example of purchase history 104a;

FIG. 5 is a diagram showing an example of price information 105a;

FIG. 6 is a sequence diagram for describing operations of fraudulent-purchase alarm system 100;

FIG. 7 is a diagram showing an example of customer information modification history 106c1 held in fraud check server 106c;

FIG. 8 is a sequence diagram for describing operations of fraudulent-purchase alarm system 100;

FIG. 9 is a diagram showing a fraudulent-purchase alarm system including upper limit storage server 103, purchase history storage server 104, price storage server 105, and controller 106; and

FIG. 10 is a block diagram showing fraudulent-purchase alarm system 100A in a second exemplary embodiment.

### DETAILED DESCRIPTION OF THE EXEMPLARY EMBODIMENTS

Exemplary embodiments will be described below with reference to the drawings.

### First Exemplary Embodiment

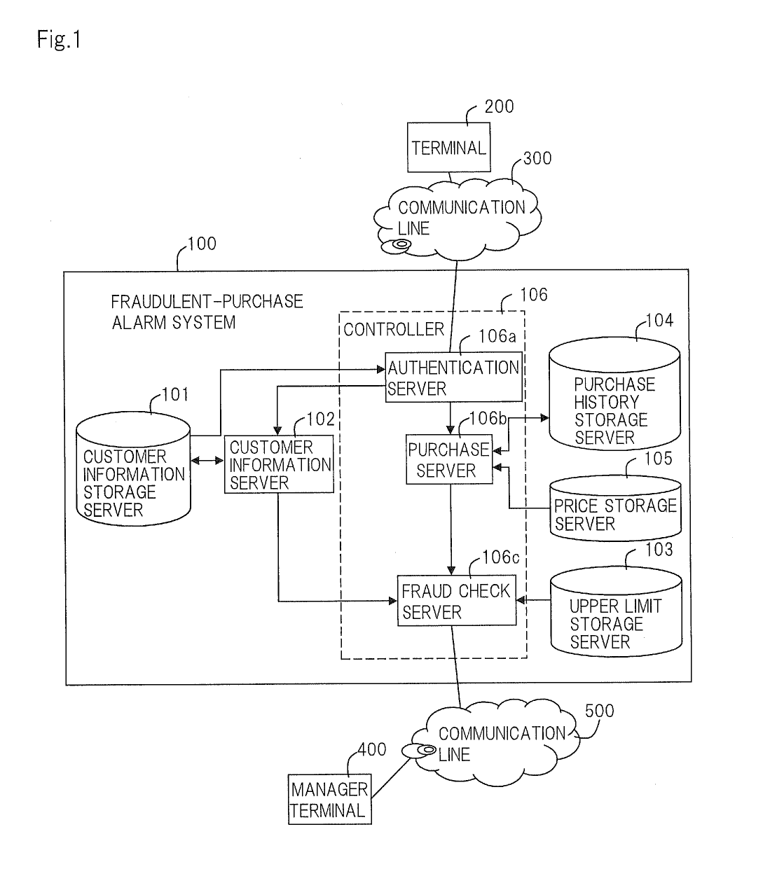

FIG. 1 is a block diagram showing a fraudulent-purchase alarm system according to a first exemplary embodiment of the present invention.

In FIG. 1, fraudulent-purchase alarming system 100 communicates with terminal 200 via communication line 300, and communicates with manager terminal 400 via communication line 500. Communication line 300 may act as communication line 500, as well.

Fraudulent-purchase alarming system 100 includes functions of receiving identification information about a user of fraudulent-purchase alarm system 100 (hereinafter referred to as a “user ID”) and a purchase request to purchase an article for sale, such as a commodity, content, or a service, and selling the article indicated in the purchase request to the user identified by the user ID. In the exemplary embodiment, the purchase request includes an article ID for identifying the article requested to be purchased. The purchase request is also referred to as a purchase application.

Fraudulent-purchase alarm system 100 includes customer information storage server 101, customer information server 102, upper limit storage server 103, purchase history storage server 104, price storage server 105, and controller 106.

Customer information storage server 101 is an example of fourth storage means.

Customer information storage server 101 stores information about users of fraudulent-purchase alarm system 100 (hereinafter referred to as “user information”). In the following, a user of fraudulent-purchase alarm system 100 will be simply referred to as a “user.”

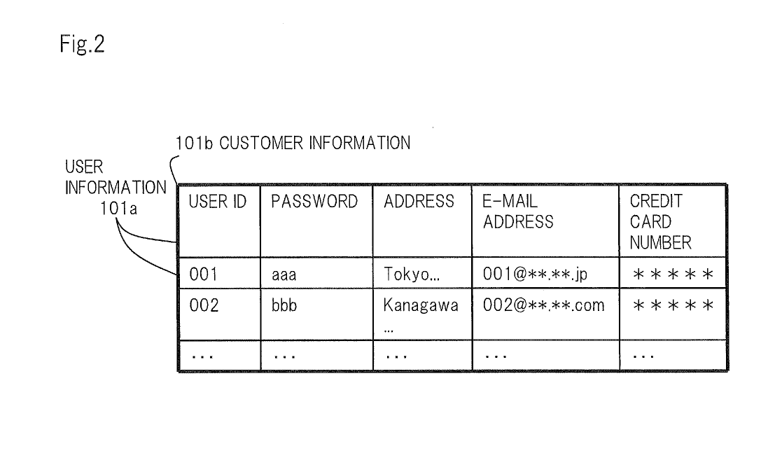

FIG. 2 is a diagram showing an example of customer information 101b including items of user information 101a.

In FIG. 2, each item of user information 101a corresponds to a user ID. Each item of user information 101a involves a user's user ID, password, address, e-mail address, and credit card number, which are associated with each other. The user ID is an example of identification information about a user.

Customer information server 102 is an example of management means.

Upon receiving a modification instruction to modify user information, customer information server 102 modifies user information 101a in customer information storage server 101 based on the modification instruction.

In the exemplary embodiment, a user ID is attached to the modification instruction.

Customer information server 102 identifies, among the items of user information 101a in customer information storage server 101, an item of user information (hereinafter referred to as “user information to be modified”) that includes the user ID attached to the modification instruction.

According to the modification instruction, customer information server 102 modifies an item (for example, the user's e-mail address) indicated in the modification instruction among the items (the user's user ID, password, address, e-mail address, and credit card number) of the user information to be modified.

Upon receiving a registration instruction with new user information 101a attached thereto, customer information server 102 stores new user information 101a attached to the registration instruction in customer information storage server 101.

Upper limit storage server 103 is an example of third storage means.

Upper limit storage server 103 stores the upper limit of the total purchase amount (hereinafter simply referred to as the “upper limit”) of each user. In the exemplary embodiment, upper limit storage server 103 stores the upper limit within a predetermined period (for example, one month). The predetermined period is not limited to one month but may be changed as appropriate.

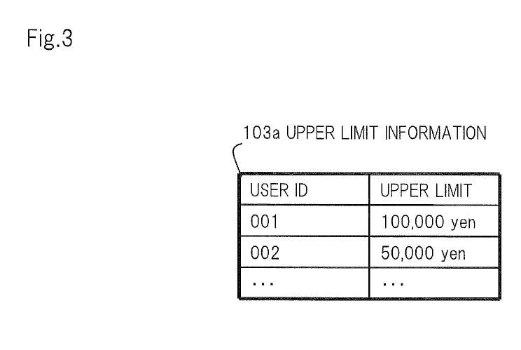

FIG. 3 is a diagram showing an example of upper limit information 103a stored in upper limit storage server 103, indicating the upper limit for each user.

In FIG. 3, upper limit information 103a for each user ID indicates the upper limit for a user identified by the user ID.

Purchase history storage server 104 is an example of second storage means.

Purchase history storage server 104 stores purchase histories of the users.

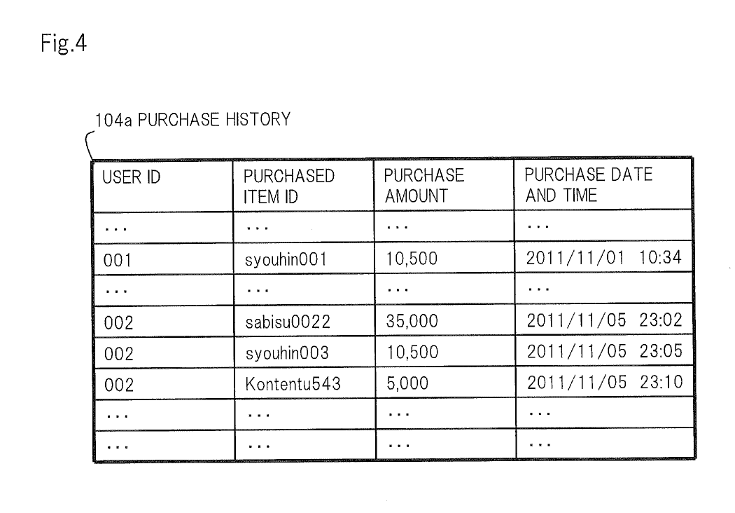

FIG. 4 is a diagram showing an example of purchase history 104a.

In FIG. 4, purchase history 104a for each purchase involves a user ID of a user who made the purchase, a purchased item ID for identifying a purchased article for sale, a purchase amount, and purchase date and time, which are associated with each other. In the exemplary embodiment, an article ID is used as the purchased item ID.

Price storage server 105 is an example of first storage means.

Price storage server 105 stores price information indicating the price of each article for sale sold by fraudulent-purchase alarm system 100.

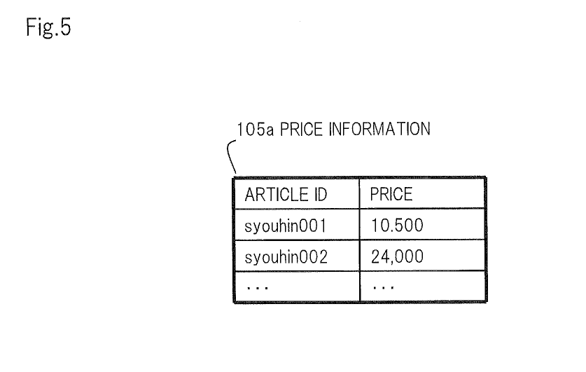

FIG. 5 is a diagram showing an example of price information 105a.

In FIG. 5, price information 105a for each article ID indicates the price of an article for sale identified by the article ID.

Controller 106 is an example of control means.

Upon receiving a purchase request to purchase an article for sale and a user ID, controller 106 refers to purchase history storage server 104 and price storage server 105 to calculate the sum of “the total purchase amount of a user identified by the user ID” and “the price of the article requested to be purchased” (hereinafter referred to as the “total sum”). If the total sum exceeds the upper limit for the user identified by the user ID among the upper limits in upper limit storage server 103, controller 106 issues a fraudulent-purchase alarm.

Also, if a predetermined condition for preventing a fraudulent purchase (hereinafter simply referred to as a “predetermined condition”) is met, controller 106 lowers the upper limit that is associated with the received user ID and that is to be compared with the total sum.

For example, the following conditions may be used as the predetermined condition:

(1) an update condition in which user information 101a including the received user ID has been updated in customer information server 102,

(2) a new registration condition in which customer information server 102 has stored new user information 101a including the received user ID,

(3) an excess purchase condition in which the number of articles for sale indicated in purchase requests within a predetermined period (for example, one week) exceeds a predetermined number (for example, 10),

(4) an article condition in which the article for sale indicated in the purchase request is a predetermined article for sale, and

(5) a period condition in which the current date and time fall within a specific period (for example, immediately after the settlement day of the amount charged for purchased items, e.g., the beginning of a month in the case of end-of-month settlement).

The predetermined condition is not limited to the above conditions (1) to (5) but may be changed as appropriate, or even may be a combination of any of the above conditions (1) to (5).

Controller 106 includes authentication server 106a, purchase server 106b, and fraud check server 106c.

Authentication server 106a uses customer information storage server 101 to authenticate terminal 200 that has sent a user ID and a password for logging in to fraudulent-purchase alarm system 100.

In the exemplary embodiment, authentication server 106a authenticates terminal 200 if user information 101a including both the user ID and the password sent from terminal 200 is present in customer information storage server 101.

Upon receiving a modification instruction or a registration instruction from authenticated terminal 200, authentication server 106a outputs the modification instruction or the registration instruction to customer information server 102.

When customer information server 102 modifies user information 101a according to the modification instruction, customer information server 102 outputs a modification history to fraud check server 106c. When customer information server 102 registers new user information 101a according to the registration instruction, customer information server 102 outputs a registration history to fraud check server 106c.

Upon receiving a purchase request from authenticated terminal 200, authentication server 106a outputs the purchase request to purchase server 106b along with the user ID used for the authentication of terminal 200.

Purchase server 106b manages purchases of articles for sale by terminal 200.

Upon receiving a purchase request and a user ID, purchase server 106b refers to purchase history storage server 104 and price storage server 105 to calculate the sum of “the total purchase amount of a user identified by the user ID” and “the price of an article for which a purchase request has been made” (the total sum).

Purchase server 106b outputs at least the total sum and the user ID to fraud check server 106c.

Fraud check server 106c checks for a fraud related to the purchase of an article for sale made by terminal 200. Fraud check server 106c includes an internal clock (not shown) indicating the current date and time.

Upon receiving the total sum and the user ID from purchase server 106b, fraud check server 106c refers to upper limit storage server 103 to identify the upper limit associated with the user ID.

If the predetermined condition is met, fraud check server 106c performs a changing process for lowering the upper limit by a predetermined value or by a predetermined percentage. Then, if the total sum exceeds the changed upper limit, fraud check server 106c sends alarm information (an alarm) indicating the possibility of a fraudulent purchase to manager terminal 400. The predetermined condition is held in fraud check server 106c.

If the predetermined condition is not met, fraud check server 106c does not perform the changing process. Then, if the total sum exceeds the upper limit, fraud check server 106c sends the alarm information to manager terminal 400.

Manager terminal 400 is an example of a predetermined terminal. Manager terminal 400 is operated by, for example, a manager of fraudulent-purchase alarm system 100.

Now, operations will be described.

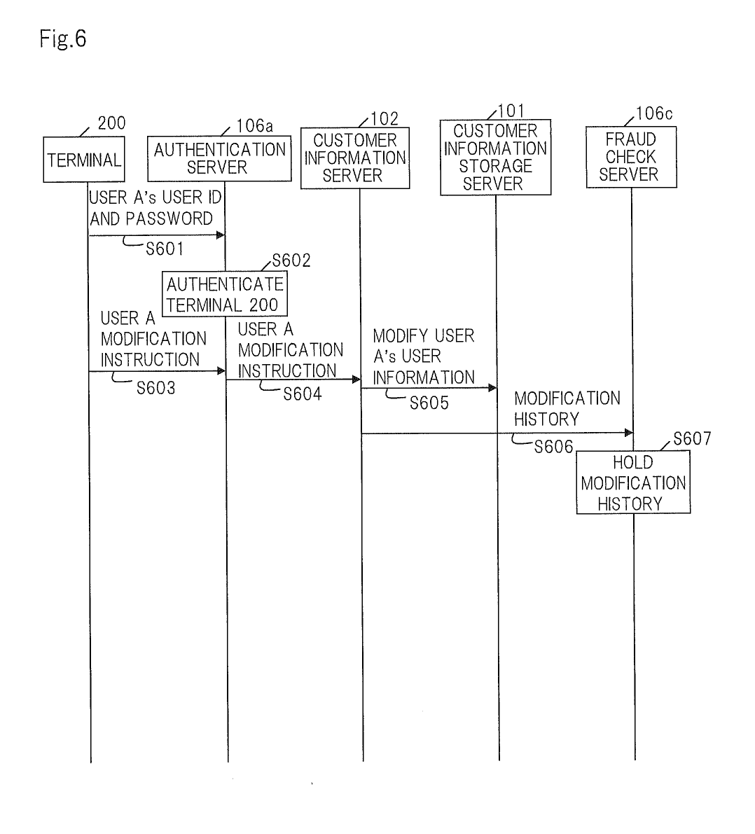

FIG. 6 is a sequence diagram for describing operations of fraudulent-purchase alarm system 100 in the case that a user X of terminal 200 uses a fraudulently obtained user ID and password of a user A to modify user information about the user A in fraudulent-purchase alarm system 100.

When the user X inputs the user A's user ID and password to terminal 200 for logging in to authentication server 106a, terminal 200 sends the user A's user ID and password to authentication server 106a (step S601).

Upon receiving the user ID and the password, authentication server 106a authenticates terminal 200 using customer information storage server 101 (step S602).

Next, the user X then inputs a modification instruction for changing the user A's e-mail address to be used for contacting the user A (hereinafter referred to as a “user A modification instruction”) to terminal 200 in order to, for example, delay the discovery of the fraudulent use of the user A's user ID and password. The user A modification instruction has the user A's user ID attached thereto.

Terminal 200 receives the user A modification instruction and sends it to authentication server 106a (step S603).

Authentication server 106a receives the user A modification instruction from terminal 200 and sends it to customer information server 102 (step S604).

Upon receiving the user A modification instruction, customer information server 102 identifies, as user information to be modified, user information including the user A's user ID attached to the user A modification instruction in user information 101a in customer information storage server 101.

Next, customer information server 102 modifies, according to the user A modification instruction, an item indicated in the user A modification instruction (for example, the user's e-mail address) among the items of the user information to be modified (step S605).

Next, customer information server 102 sends a history of the modification made in step S605 to fraud check server 106c (step S606).

Fraud check server 106c receives and holds the modification history (step S607).

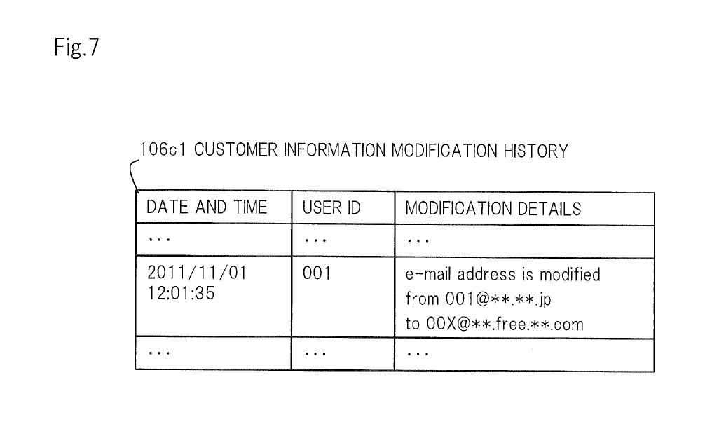

FIG. 7 is a diagram showing an example of customer information modification history 106c1 held in fraud check server 106c.

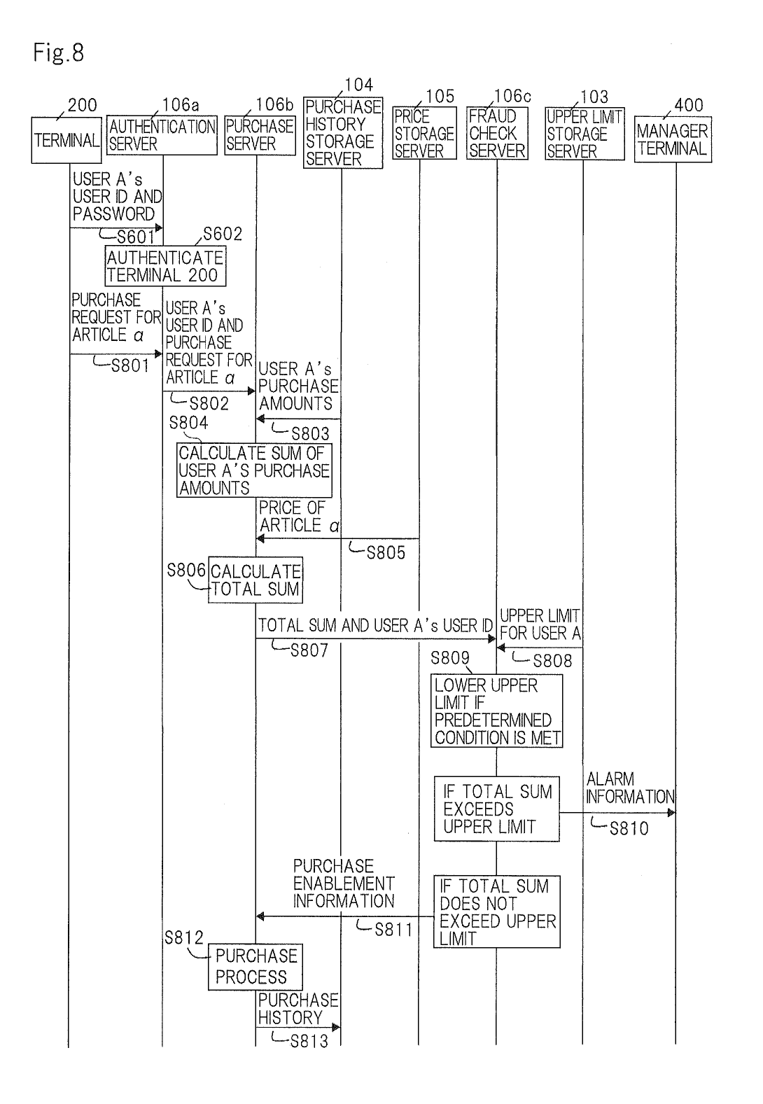

FIG. 8 is a sequence diagram for describing operations of fraudulent-purchase alarm system 100 in the case that user X of terminal 200 uses the fraudulently obtained user ID of user A to purchase an article for sale in fraudulent-purchase alarm system 100.

In FIG. 8, the same processes as shown in FIG. 6 are labeled with the same symbols. In the following, operations of fraudulent-purchase alarming system 100 will be described mainly with respect to processes that are different from those shown in FIG. 6.

After step S602, the user X inputs a purchase request to purchase an article for sale α, such as a commodity, a cash voucher, a game, an item, content, or a service (hereinafter referred to as a “purchase request for an article α”) to terminal 200.

Terminal 200 receives the purchase request for the article α and sends it to authentication server 106a (step S801).

Authentication server 106a receives the purchase request for the article α from authenticated terminal 200 and sends it to purchase server 106b along with the user A's user ID used for the authentication of terminal 200 (step S802).

Purchase server 106b receives the purchase request for the article α and user A's user ID. Purchase server 106b reads, from purchase history 104a in purchase history storage server 104, purchase amounts on purchase dates and times within a predetermined period (for example, a period from the first day of the current month to the current day) from among purchase amounts associated with the user A's user ID (step S803). The predetermined period may be changed as appropriate.

Next, purchase server 106b calculates the sum of the purchase amounts associated with user A's user ID (step S804).

Next, purchase server 106b reads the price of the article α from price storage server 105 (step S805).

Next, purchase server 106b calculates the total sum of the sum calculated in step S804 and the price of the article α (step S806).

Next, purchase server 106b sends the total sum and user A's user ID to fraud check server 106c (step S807).

Fraud check server 106c receives the total sum and user A's user ID from purchase server 106b and reads the upper limit for user A from upper limit storage server 103 (step S808).

Next, fraud check server 106c refers to the modification history held by fraud check server 106c (see step S607). If the modification history within the predetermined period meets the predetermined condition (in this example, the update condition), fraud check server 106c performs the changing process for lowering the upper limit for user A read from upper limit storage server 103 by a predetermined value (for example, 50,000 yen) or by a predetermined percentage (for example, 50%) (step S809). The predetermined value and the predetermined percentage are not limited to 50,000 yen and 50%, respectively, but may be changed as appropriate.

If the modification history within the predetermined period does not meet the predetermined condition, fraud check server 106c does not change the upper limit for user A read from upper limit storage server 103.

Next, fraud check server 106c compares the total sum and the upper limit. If the total sum exceeds the upper limit, fraud check server 106c sends manager terminal 400 alarm information (an alarm) indicating the possibility that a fraudulent purchase has been made using user A's user ID (step S810).

At this point, fraud check server 106c may send purchase disablement information for disabling purchases to purchase server 106b, thereby stopping purchase server 106b from carrying out further processing operations with the result that no more purchases can be made using user A's user ID. In this case, fraud check server 106c does not prevent terminal 200 from communicating with fraudulent-purchase alarm system 100 using user A's user ID.

If the total sum does not exceed the upper limit, fraud check server 106c sends purchase enablement information for enabling the purchase to purchase server 106b (step S811).

Purchase server 106b receives the purchase enablement information and performs a purchase operation for article α (step S812). Purchase server 106b adds the purchase history of user A's purchase of article α to purchase history storage server 104 (step S813).

Now, advantages of the exemplary embodiment will be described.

According to the exemplary embodiment, upper limit storage server 103 stores the upper limit of the total purchase amount of each user of fraudulent-purchase alarm system 100. Purchase history storage server 104 stores the purchase amounts of articles for sale purchased by the users. Price storage server 105 stores the prices of articles for sale. Controller 106, upon receiving a purchase request to purchase an article for sale and a user's user ID, refers to upper limit storage server 103, purchase history storage server 104, and price storage server 105. If the total sum of “the amount of purchases by the user identified by the user ID” and “the price of the article for which a purchase request has been made” exceeds the upper limit, controller 106 issues a fraudulent-purchase alarm.

Also, if the predetermined condition for preventing a fraudulent purchase is met, controller 106 lowers the upper limit.

Thus, if the predetermined condition for preventing a fraudulent purchase is met, the total sum is more likely to exceed the upper limit and therefore an alarm is more likely to be issued. This allows earlier detection of a fraudulent purchase made by a third party who has fraudulently obtained a user's user ID.

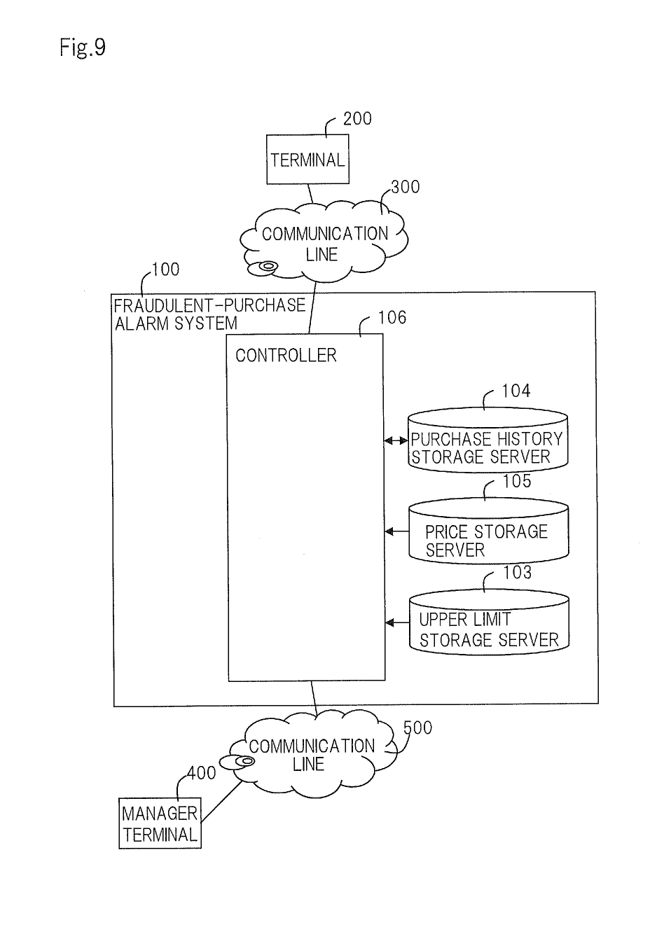

The above advantage is achieved by even a fraudulent-purchase alarm system including upper limit storage server 103, purchase history storage server 104, price storage server 105, and controller 106. FIG. 9 is a diagram showing a fraudulent-purchase alarm system including upper limit storage server 103, purchase history storage server 104, price storage server 105, and controller 106.

In the exemplary embodiment, customer information storage server 101 stores user information. Upon receiving a modification instruction to modify the user information, customer information server 102 modifies the user information in customer information storage server 101 based on the modification instruction.

A predetermined condition for preventing a fraudulent purchase that may be used is the update condition in which user information identified by a user ID used in purchasing an article for sale has been updated in customer information storage server 101.

For example, a user X who is attempting a fraudulent purchase using user A's user ID could change user A's e-mail address that is to be used for contacting user A in order to delay the discovery of the user X's fraudulent purchase.

As such, as the predetermined condition for preventing a fraudulent purchase, an update condition may be used (for example, an update condition in which the e-mail address of a user identified by the user ID used in requesting a purchase of an article for sale has been updated in customer information server 102). Consequently, a fraudulent-purchase alarm is more likely to be issued. This allows earlier detection of a fraudulent purchase made by a third party who has fraudulently obtained a user's user ID. Alternatively, the predetermined condition for preventing a fraudulent purchase may be a condition in which user A's e-mail address that is to be used for contacting the user A has been changed to, or registered as, an e-mail address available for free.

The user X could also change the user A's address in order to cause the article fraudulently purchased by the user X to be delivered to where the user X wants to receive the article.

As such, as the predetermined condition for preventing a fraudulent purchase, an update condition may be used (for example, an update condition in which the address of a user identified by a user ID used in making a request to purchase an article that is for sale has been updated in customer information server 102). Consequently, a fraudulent-purchase alarm is more likely to be issued.

The user X could also change the user A's credit card number to a fraudulently obtained credit card number of somebody else in order to complicate the fraudulent purchase.

As such, as the predetermined condition for preventing a fraudulent purchase, an update condition may be used (for example, an update condition in which the credit card number of a user identified by a user ID used in making a request to purchase an article that is for sale has been updated in customer information server 102). Consequently, a fraudulent-purchase alarm is more likely to be issued.

Another predetermined condition for preventing a fraudulent purchase that may be used is a new registration condition in which user information including a user ID used in making a request to purchase an article that is for sale has been stored in customer information storage server 101.

In this case, fraud check server 106c holds registration histories from customer information server 102 for a certain period (for example, one month). Referring to the registration histories, fraud check server 106c determines whether the new registration condition is met.

The use of a new registration condition as the predetermined condition for preventing a fraudulent purchase makes it more likely that a fraudulent purchase alarm will be issued when user X impersonates a fictitious user or some other user.

Another predetermined condition for preventing a fraudulent purchase that may be used is an excess purchase condition in which the number of articles for sale indicated in purchase requests within a predetermined period exceeds a predetermined number.

In this case, when purchase server 106b receives a user ID and a purchase request, purchase server 106b refers to purchase history storage server 104 to calculate the number of articles for sale indicated in purchase requests made using the user ID within a predetermined period. Purchase server 106b outputs the calculation result to fraud check server 106c. Fraud check server 106c uses the calculation result to determine whether the excess purchase condition is met.

The use of the excess purchase condition as the predetermined condition for preventing a fraudulent purchase makes it more likely that a fraudulent-purchase alarm will be issued when user X attempts to fraudulently purchase many articles for sale within the predetermined period.

Another predetermined condition for restraining a fraudulent purchase that may be used is an article condition in which an article for sale indicated in a purchase request is a predetermined article for sale (for example, a game readily convertible into cash).

In this case, purchase server 106b outputs an article ID of an article for sale indicated in a purchase request to fraud check server 106c along with the total sum. Fraud check server 106c uses the article ID from purchase server 106b to determine whether the article condition is met.

The use of an article condition as the predetermined condition for preventing a fraudulent purchase makes it more likely that a fraudulent-purchase alarm will be issued when user X attempts to purchase a predetermined article for sale (for example, a game readily convertible into cash).

Another predetermined condition for preventing a fraudulent purchase that may be used is a period condition in which the current date and time falls within a specific period (for example, immediately after the settlement day of the amount charged for purchased items, e.g., the beginning of a month in the case of end-of-month settlement).

In this case, fraud check server 106c determines whether the period condition is met using the current date and time indicated by the internal clock in fraud check server 106c.

The use of a period condition as the predetermined condition for preventing a fraudulent purchase makes it more likely that a fraudulent purchase alarm will be issued when a fraudulent purchase is made in a situation in which, for example, only a few articles for sale have been purchased such as immediately after the settlement day of the amount charged.

In the exemplary embodiment, controller 106 provides, as an alarm, alarm information indicating the possibility of a fraudulent purchase to manager terminal 400.

This allows a manager operating manager terminal 400 to recognize the alarm information and start investigating any fraudulent purchase.

Fraud check server 106c does not rewrite the upper limit in upper limit storage server 103. Rather, if the predetermined condition for preventing a fraudulent purchase is met at the time of a purchase request, fraud check server 106c changes the upper limit that is read from upper limit storage server 103 when comparing the upper limit with the total sum. This can eliminate the process of rewriting the upper limit in upper limit storage server 103.

In the exemplary embodiment, upper limit storage server 103 may store a common upper limit, rather than managing the upper limit for each user ID. In this case, fraud check server 106c uses the common upper limit instead of the upper limit associated with each user ID.

All the servers in fraudulent-purchase alarm system 100 may be included in a single apparatus, or each server in fraudulent-purchase alarm system 100 may be separately provided, or at least any two or more of the servers in fraudulent-purchase alarming system 100 may be included in a single apparatus.

Customer information modification history (see FIG. 7) stored in fraud check server 106c may be stored in an independent storage server like storage servers 103 to 105.

Each of storage servers 103 to 105 may be included in any of authentication server 106a, purchase server 106b, or fraud check server 106c.

### Second Exemplary Embodiment

Now, a second exemplary embodiment of the present invention will be described.

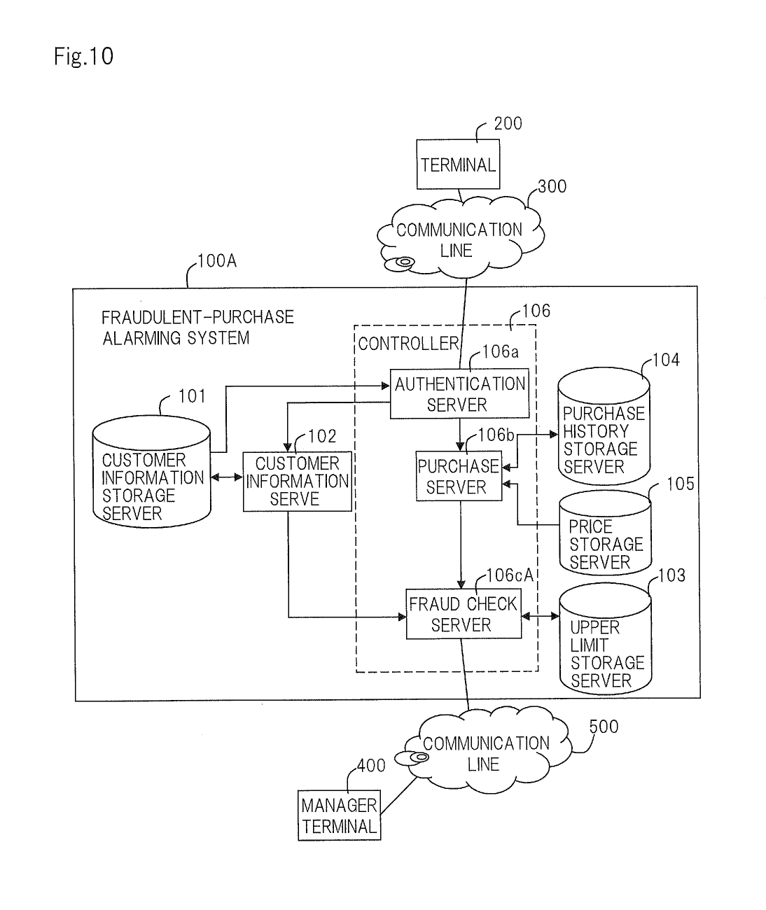

FIG. 10 is a block diagram showing fraudulent-purchase alarming system 100A in the second exemplary embodiment.

In FIG. 10, the same components as shown in FIG. 1 are labeled with the same symbols. In the following, fraudulent-purchase alarming system 100A shown in FIG. 10 will be described mainly with respect to showing the differences between fraudulent purchase alarm system 100A shown in FIG. 10 and fraudulent purchase alarm system 100 shown in FIG. 1.

Fraudulent-purchase alarm system 100A shown in FIG. 10 employs fraud check server 106cA instead of fraud check server 106c shown in FIG. 1.

Fraud check server 106cA, like fraud check server 106c, checks for a fraud related to a purchase of an article for a sale made by terminal 200, and includes an internal clock (not shown).

If the predetermined condition for preventing a fraudulent purchase is met, fraud check server 106cA performs a rewrite process for rewriting an upper limit in upper limit storage server 103 to an upper limit lowered by a predetermined value or by a predetermined percentage. The predetermined condition for preventing a fraudulent purchase is held in fraud check server 106cA.

For example, consider the case in which the update condition used as the predetermined condition is met. In this case, fraud check server 106cA does not perform the operation of holding the modification history illustrated in step S607 in the first exemplary embodiment, but rewrites an upper limit associated with a user ID in modified user information 101a among the upper limits in upper limit storage server 103.

Consider the case in which a new registration condition used as the predetermined condition is met. That is, fraud check server 106cA receives a registration history from customer information server 102. In this case, fraud check server 106cA rewrites an upper limit associated with a user ID in user information 101a indicated in the registration history among the upper limits in upper limit storage server 103.

Consider the case in which an excess purchase condition used as the predetermined condition is met. That is, when purchase server 106b receives a user ID and a purchase request, purchase server 106b refers to purchase history storage server 104 to calculate the number of articles for sale indicated in purchase requests made using the user ID within a predetermined period. Purchase server 106b outputs the calculation result and the user ID to fraud check server 106cA, and the fraud check server 106cA uses the calculation result to determine that the excess purchase condition is met. In this case, fraud check server 106cA rewrites an upper limit associated with the user ID received along with the calculation result among the upper limits in upper limit storage server 103.

Consider the case in which the article condition used as the predetermined condition is met. That is, purchase server 106b outputs an article ID of an article for sale indicated in a purchase request to fraud check server 106cA along with the total sum and a user ID. Fraud check server 106cA uses the article ID from purchase server 106b to determine that the article condition is met. In this case, fraud check server 106cA rewrites an upper limit associated with the user ID received along with the article ID among the upper limits in upper limit storage server 103.

Consider the case in which the period condition used as the predetermined condition is met. That is, fraud check server 106cA determines that the current date and time indicated by the internal clock in fraud check server 106cA falls within a specific period defined by the period condition. In this case, fraud check server 106cA rewrites all the upper limits in upper limit storage server 103.

Upon receiving the total sum and the user ID from purchase server 106b, fraud check server 106cA refers to upper limit storage server 103 to read the upper limit associated with the user ID. If the total sum exceeds the upper limit in upper limit storage server 103, fraud check server 106cA sends alarm information (an alarm) indicating the possibility of a fraudulent purchase to manager terminal 400.

After changing the upper limit in upper limit storage server 103, fraud check server 106cA resets the changed upper limit to a value before being changed (for example, a default value) upon receiving a successful payment notification that a charged purchase amount has been properly paid or a notification that no trouble has occurred from manager terminal 400, or upon a lapse of a certain period after changing the upper limit.

The exemplary embodiment, as in the first exemplary embodiment, allows earlier detection of a fraudulent purchase made by a third party who has fraudulently obtained a user's user ID.

Fraudulent-purchase alarm system 100 or 100A may be implemented by a computer. In this case, the computer reads and executes a program recorded on a computer-readable recording medium such as a CD-ROM (Compact Disk Read Only Memory), thereby functioning as customer information storage server 101, customer information server 102, upper limit storage server 103, purchase history storage server 104, price storage server 105, and controller 106. The recording medium is not limited to a CD-ROM but may be any appropriate medium.

All the servers in fraudulent-purchase alarm system 100A may be included in a single apparatus, or each server in fraudulent-purchase alarm system 100A may be separately provided, or at least any two or more of the servers in fraudulent-purchase alarming system 100A may be included in a single apparatus.

An exemplary advantage of the present invention is that a fraudulent purchase made by a third party who has fraudulently obtained a user's user ID can be detected earlier.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A fraudulent-purchase alarm system for issuing an alarm about a fraudulent purchase of an article for sale, the system comprising:
a first storage that stores a price of the article for sale;
a second storage that stores purchase amounts of articles for sale purchased by a user of the fraudulent-purchase alarm system;
a third storage that stores an upper limit of a total purchase amount of the user; and
a controller that, upon receiving both a purchase request to purchase the article for sale and identification information about the user, refers to said first to third storages to issue an alarm about a fraudulent purchase if a sum of the purchase amounts of articles already purchased by the user identified by the identification information and the price of the article for sale indicated in the purchase request exceeds the upper limit,
wherein said controller lowers the upper limit if a predetermined condition for preventing a fraudulent purchase is met.

2. The fraudulent-purchase alarm system according to claim 1, further comprising:
a fourth storage that stores information about the user; and
a manager that, upon receiving a modification instruction to modify the information about the user, modifies the information about the user in said fourth storage based on the modification instruction,
wherein the predetermined condition is an update condition in which the information about the user identified by the identification information has been updated in said fourth storage, or a new registration condition in which said fourth storage has stored the information about the user.

3. The fraudulent-purchase alarm system according to claim 1, wherein the predetermined condition is a condition in which the number of articles for sale indicated in purchase requests in a predetermined period exceeds a predetermined number, a condition in which the article for sale indicated in the purchase request is a predetermined article for sale, or a condition in which current date and time falls within a specific period.

4. The fraudulent-purchase alarm system according to claim 2, wherein the information about the user is the user's e-mail address, the user's address, or the user's credit card number.

5. The fraudulent-purchase alarm system according to claim 1, wherein said controller provides a predetermined terminal with information about possibility of occurrence of a fraudulent purchase as the alarm about the fraudulent purchase.

6. The fraudulent-purchase alarm system according to claim 1, wherein the article for sale is any from among a commodity, a service, electronic information, or content.

7. A fraudulent-purchase alarm method in a fraudulent-purchase alarm system for issuing an alarm about a fraudulent purchase of an article for sale, the method comprising:
storing a price of the article for sale in a first storage;
storing purchase amounts of articles for sale purchased by a user of the fraudulent-purchase alarm system in a second storage;
storing an upper limit of a total purchase amount of the user in a third storage;
upon receiving a purchase request to purchase the article for sale and identification information about the user, referring to the first to third storages to issue an alarm about a fraudulent purchase if a sum of the purchase amounts of articles already purchased by the user identified by the identification information and the price of the article for sale indicated in the purchase request exceeds the upper limit; and
lowering the upper limit if a predetermined condition for preventing a fraudulent purchase is met.

8. A computer-readable recording medium having recorded therein a program for causing a computer to perform:
a first storage process of storing a price of an article for sale in a first storage;
a second storage process of storing, in a second storage, purchase amounts of articles for sale purchased by a user of a fraudulent-purchase alarm system for issuing an alarm about a fraudulent purchase of an article for sale;
a third storage process of storing an upper limit of a total purchase amount of the user in a third storage;
a control process of, upon receiving a purchase request to purchase the article for sale and identification information about the user, referring to the first to third storages to issue an alarm about a fraudulent purchase if a sum of the purchase amounts of articles already purchased by the user identified by the identification information and the price of the article for sale indicated in the purchase request exceeds the upper limit; and
an upper limit changing process of lowering the upper limit if a predetermined condition for preventing a fraudulent purchase is met.
